(19) United States
(12) Patent Application Publication
(10) Pub. No.: US 2012/0048076 A1
(43) Pub. Date: Mar. 1, 2012

(54) Method And Device For Slicing Loaves Of Bread

(75) Inventor: André Hahn, Buizingen (BE)

(73) Assignee: HAHN A. bvba, Buizingen (BE)

(21) Appl. No.: 12/872,325

(22) Filed: Aug. 31, 2010

(51) Int. Cl. B26D 1/00; B26D 7/06; A47J 43/04

(52) U.S. Cl. 83/13; 99/537; 83/444

(57) ABSTRACT

The present invention relates to a method for slicing loaves of bread, particularly loaves having an oblong or essentially oblong shape, and to a device for the implementation of the said method.

This method is characterized in that, inside a housing consisting of one or more longitudinal lateral walls defining a first compartment for the introduction of the loaf of bread to be sliced, and a second, cutting compartment, one of whose lateral walls, or whose sole lateral wall, is provided, in proximity to the cutting compartment, with a longitudinal slot for the passage of a circular blade that can rotate counterclockwise and that is mounted rotatively on a shaft external to the housing, the loaf is placed in the first compartment after the distance inside the housing between the extremity of the blade and, located facing the slot, the means for guiding the loaf, has been adjusted as necessary, such that, due to the effect of the rotating blade, the loaf, to which motion has been imparted by the tractive force of the said blade, is sliced longitudinally over its entire width or over a portion thereof, and the sliced loaf is then received.

The present invention relates generally to a method for slicing loaves of bread and to a device for the implementation of the said method.

More specifically, the invention involves a method for slicing loaves of bread, particularly loaves having an oblong or essentially oblong shape, such as baguette loaves and round or elongated bread rolls.

Loaves having an oblong shape (such as, for example, those known commonly as bread rolls, baguettes, thin baguette loaves [“ficelles”], and ciabatta loaves, among others) are generally consumed after having been sliced longitudinally and over the entirety of their width, so as to separate them into two halves, or over a fraction of their width, so as to open them. This maneuver is typically performed in an entirely manual way, with the one of the operator's hands firmly holding the loaf to be sliced, while the other hand performs the cut per se, using a suitable knife. However, this maneuver entails several disadvantages for the operator, the consumer, and the environment. The operator runs the risk of injury to the palm of the hand or to the fingers, as well as the occurrence of irritations or even of scratches due to the abrasive effect of the crust of the loaves when the loaves are handled too frequently. Furthermore, the handling of the loaf to be sliced by the operator falls short of ensuring the level of hygiene desired by the consumer. Last, the slicing maneuver, which is customarily performed on a worktable, causes the scattering of numerous crumbs, which contaminate the environment.

Devices for slicing loaves of bread are already known. For example, German patent application No. DE 19829107 describes a device for cutting bread rolls that are placed in the cavity of a housing. This cavity, which is provided with blades that oscillate in a slot formed in its lower portion, is also provided with a clamping shoe actuated by a handle located on two vertical bars in order to push the loaf toward the blades. Furthermore, an opening allows the cut roll to be collected, with the crumbs being gathered in a receptacle.

Similarly, German utility model No. DE 20 2004006594 U1 describes a device for cutting bread rolls and baguette loaves, which device includes two parallel U-shaped compartments of equal size that are linked longitudinally, along with a horizontal circular blade that allows a cut to be made in each of the compartments. The blade is actuated by an electrical motor, either or both of which can be raised or lowered by means of a lift so that height adjustments can be made. A toothed chain or belt pushes the bread rolls and baguette loaves toward the cutting blade.

Reference may also be made to German utility model No. DE 20 2005018732 U1, which describes a device for automatically cutting bread rolls and baguette loaves, which device includes an inclined compartment that is divided horizontally by a circular blade oriented parallel to the base of the said compartment. In the said compartment, after a separating wall has been lowered via control means, the baguette loaf or the bread roll to be sliced slides toward the blade and passes across it due to the action of a pusher dog. The said blade divides the baguette loaf or the bread roll horizontally, such that the loaf or the roll then falls into a lower compartment, from which it can be recovered through a slot. The pusher dog is divided into two parts, one of which is located below the blade and the other of which is located above it.

Furthermore, European patent No. EP 0615821 describes a device for cutting loaves of bread, which device includes a compartment located forward of the cutting blades. The loaf is introduced into this device through an insertion aperture, and is directed toward the blades by a guide plate while sliding along a platform.

However, none of the above-mentioned devices can slice a baguette loaf or a bread roll through its entire length while adjusting the depth of the cut in relation to the width of the loaf or roll, so as to slice through the entirety of the said width and also, if necessary, so as to slice through a fraction of the said width, so as to produce a longitudinal opening in the baguette loaf or in the roll.

The goal of the present invention is to propose a method, of the type described above, that can remedy the said disadvantages by allowing oblong loaves of bread to be sliced, not only over the entirety of their length, but also, and in particular, over their width, depending on the desired depth of the said width (i.e., over their entire width or over a portion thereof), doing so while ensuring the safety of the user.

To achieve this goal, the method according to the invention is characterized in that, inside a housing consisting of one or more longitudinal lateral walls defining a first compartment, known as the “feeding compartment”, for the introduction of the loaf of bread to be sliced, and a second compartment, known as the “cutting compartment”, one of whose lateral walls, or whose sole lateral wall, is provided, in proximity to the cutting compartment, with a longitudinal slot for the passage of a circular cutting blade that can rotate counterclockwise and that is mounted rotatively on a shaft external to the housing, the loaf is placed in the feeding compartment after the distance inside the housing between the extremity of the blade and, located facing the slot, the means for guiding the loaf, has been adjusted as necessary, such that, due to the effect of the rotating blade, the loaf, to which motion has been imparted by the tractive force of the said rotating blade, is sliced longitudinally over its entire width or over a portion thereof, and the sliced loaf is then received.

Within the context of the present invention, the term “lateral wall” refers more specifically to a lateral wall of the housing, which housing is configured in the form of a polyhedron, i.e., a wall that is defined by two transverse edges and two longitudinal edges, such as a wall of a parallelepiped.

Similarly, the term “portion of a lateral wall” refers to a portion of a sole lateral wall whose volume is defined by two transverse edges that are linked by the said wall, such as a portion of the lateral wall of a cylinder.

The distance inside the housing between the extremity of the blade and the guidance means may be adjusted in various ways, particularly by changing the position of the said guidance means and/or the position of the shaft carrying the blade.

### I. Changing the Position of the Guidance Means

A. In a first embodiment of the method according to the invention, the distance, inside the housing, between the extremity of the blade and the guidance means may be adjusted by changing the position of the guidance means, through shifting the guidance means along an axis perpendicular to the axis of the blade, from a first position at the so-called distal extremity to a second position at the so-called proximal extremity, and conversely.

Within the context of the present invention, the terms “position at the distal extremity” and “position at the proximal extremity” refer, respectively, to the position located farthest from the slot and the position located nearest to the slot.

The function of the guidance means is essentially to determine and to maintain the axis of the advancement of the loaf inside the housing, from the entrance of the feeding compartment to the outlet of the cutting compartment, and also to participate in the determination of the depth of cut, i.e., the depth to which the circular blade is introduced into the loaf along the width of the loaf.

In the feeding compartment, and essentially in proximity to the neck thereof, the guidance means are comparable not only to means for centering the loaf when it is introduced into the housing (doing so regardless of the width or thickness of the loaf), but also to means for reducing the speed at which the loaf travels inside the housing as a result of the force exerted, in the direction opposite to the feeding compartment, by the circular blade rotating at a relatively high speed.

However, in the cutting compartment, the function of the guidance means consists essentially of maintaining the direction of travel of the loaf, as initiated in the feeding compartment.

The guidance means typically include, facing the slot, the lateral wall of the housing, a portion of the sole lateral wall of the housing, or a supplemental wall associated with the interior of the housing.

This supplemental wall may be removable (i.e., separable from the housing) or, on the contrary, immovable (i.e., permanently affixed to the lateral wall facing the slot or to the portion of the sole lateral wall facing the slot).

Thus, in a first implementation of this embodiment of the method according to the invention, the guidance means include:
Either the lateral wall of the said housing or a portion of the sole lateral wall of the said housing, with the said wall or wall portion being located facing the slot; or
An immovable supplemental wall associated with, and positioned adjacent to, the lateral wall of the housing facing the slot or the portion of the sole lateral wall of the housing facing the slot, or partially inserted into the said lateral wall or into the said portion of the sole lateral wall, or wholly inserted into the said lateral wall so as to fit flush therewith, or into the said portion of the sole lateral wall so as to fit flush therewith.

Alternatively, the guidance means may correspond to a supplemental wall associated with the interior of the housing, which wall is removable because it may be replaced by an analogous supplemental wall having a different thickness, so that the distance between the said supplemental wall and the extremity of the blade can be varied.

### II. Changing the Position of the Blade Shaft

B. In a second embodiment of the method according to the invention, the distance, inside the housing, between the extremity of the blade and the guidance means may be adjusted by changing the position of the shaft carrying the blade, through shifting the said shaft, outside the housing, from a first position at the distal extremity to a second position at the proximal extremity, and conversely.

In this embodiment, the guidance means generally include, facing the slot, the lateral wall of the housing, a portion of the sole lateral wall of the housing, a supplemental wall associated with the interior of the housing, or a portion of a supplemental wall associated with the interior of the housing.

The said supplemental wall, or the said portion of the supplemental wall, is immovable; that is, it cannot be separated from the housing, it is preferably not mobile within the housing, and is located at the distal extremity.

In a preferred implementation of this embodiment of a method according to the invention, the guidance means include several portions of supplemental walls that are associated with the interior of the housing and that are subject to elastic deformation, one of which portions may be located facing the slot. For example, such guidance means may be equivalent to one or more pairs of fins, with the fins in each pair being located, inside the housing, on two facing lateral walls or on two facing portions of a sole lateral wall.

The method according to the invention may be implemented by means of a device that consists of a housing that includes one or more longitudinal lateral walls defining a first compartment, known as the “feeding compartment”, for the introduction of the loaf of bread to be sliced, and a second compartment, known as the “cutting compartment”, and, optionally, a third compartment, known as the “receiver”, for receiving the sliced loaf, which device is characterized:
In that its sole lateral wall, or one of its lateral walls, is provided, in proximity to the cutting compartment, with a slot for the passage of a circular cutting blade that can rotate counterclockwise and that is mounted rotatively on a shaft external to the housing, with the position of the said carrying shaft being stationary or movable in relation to the slot, and with the length of the portion of the blade located inside the cutting compartment being essentially equal to or less than the width of the said compartment; and
in that it includes, located inside the housing and, optionally, facing the slot, fixed or movable means for guiding the loaf of bread.

The housing generally includes a sole lateral wall that preferably corresponds to the lateral wall of a cylinder. However, in certain embodiments, this housing may include multiple walls that form a polyhedron, such as a parallelepiped. Unless it is extended by a receptacle for receiving the sliced loaf, this housing is generally open at its base, which is usually polygonal, elliptical, or, preferably, circular. The top of the resulting assembly may optionally be covered by a lid, which may be removable or which may be joined to the lateral wall or to one of the lateral walls via appropriate means, such as a hinge. Secondarily, the housing may include, on one of its lateral walls or on its sole lateral wall, a wall portion that can be opened and closed so as to provide access, if necessary, to the interior of the housing.

The slot, whose length is usually substantially greater than the diameter of the blade, is formed longitudinally in the sole lateral wall of the housing or in one of the lateral walls of a housing.

As regards the blade shaft, it may be mounted fixedly in relation to the said slot. In this case, a fraction of the width of the said blade penetrates into the cutting compartment.

However, the said shaft may be mounted movably in relation to the slot, between a position at the proximal extremity, such that the cutting line of the blade in question occupies essentially the entire width of the cutting compartment, and a position at the distal extremity, such that the cutting line of the said blade slightly penetrates the interior of the said cutting compartment.

### III. Fixed-Blade Embodiment

C. In a first embodiment of the device according to the invention, the shaft carrying the cutting blade is fixed in relation to the slot and the guidance means are positioned movably inside the housing, inside both the cutting compartment and the feeding compartment.

Thus:
a) In a first implementation of this embodiment, and as described hereinabove, the said guidance means include, facing the slot, the lateral wall of the housing or a portion of a sole lateral wall of the housing, with the said wall or a portion of the wall being movable from a position at the distal extremity to a position at the proximal extremity, and along an axis perpendicular to the shaft carrying the blade.
b) In a second implementation of this embodiment, the guidance means may advantageously be represented by a supplemental wall associated with the interior of the housing, as well as with the interior of the feeding compartment and the interior of the cutting compartment, which supplemental wall is located facing the slot.

The said supplemental wall is likewise movable, along an axis perpendicular to the shaft carrying the blade, between a position at the distal extremity and a position at the proximal extremity. In order to be shifted, the said supplemental wall interacts with appropriate means.

Generally speaking, and in a preferred embodiment, the said means of interaction correspond to a threaded rod that cooperates with internal threading machined in the thickness of the lateral wall or of the portion of the lateral wall facing the slot.

The said supplemental wall is usually:
Located adjacent to the lateral wall facing the slot, or located adjacent to the portion of the sole lateral wall facing the slot;
Or else is included, wholly or partially, in the lateral wall facing the slot, or in the portion of the sole lateral wall facing the slot, by means of a groove formed to the said lateral wall or in the said portion of the sole lateral wall.

When the supplemental wall facing the slot is wholly included in the lateral wall or in the portion of the sole lateral wall in question, the said supplemental wall fits flush with the said lateral wall or portion of the sole lateral wall.

The said supplemental wall is usually designed to be rigid.

However, according to one particular aspect of the invention, the said supplemental wall, which is immovable due to being secured by its extremities to the housing, may be elastically deformable and semi-movable. Indeed, while being shifted from its distal position (for example, due to the action of a threaded rod pushing it toward the interior of the housing in the direction of its position at the proximal extremity), the said supplemental wall, which is initially flat, is gradually deformed and adopts an arched configuration, slowly returning to its initial flat configuration as the said supplemental wall reaches its position at the distal extremity.

Furthermore, according to another aspect of the invention, the said supplemental wall associated with the interior of the housing is removable, because it may be replaced by a supplemental wall that is analogous but that has a different thickness, so that the distance separating the said supplemental wall from the extremity of the blade can be varied.

During the implementation of this first embodiment of the device according to the invention, which embodiment is characterized by a fixed position of the shaft supporting the cutting blade, the loaf is sliced over its entire width when the guidance means are in the distal position, or else is simply sliced over the smallest desired fraction of the said width when the said guidance means are in the proximal position.

### IV. Movable-Blade Embodiment

D. In a second embodiment of the device according to the invention, the shaft carrying the cutting blade is movable from a position at the proximal extremity, in relation to the slot, such that the cutting line of the said blade occupies essentially the width of the cutting compartment up to a position at the distal extremity, such that the cutting line of the said blade slightly penetrates the interior of the said cutting compartment. In this case, the guidance means are secured to the interior of the housing, usually inside the cutting compartment and inside the feeding compartment.

Thus:
a) In a first implementation of this embodiment, the fixed guidance means include, facing the slot, the lateral wall of the housing or a portion of the sole lateral wall of the housing.
b) In a second implementation of this embodiment, the fixed guidance means include, facing the slot, a supplemental wall forming a stop, associated with the interior of the housing, or a portion of a supplemental wall, likewise forming a stop and likewise associated with the interior of the housing.

However, according to a specific and preferred aspect of this second embodiment of the device according to the invention, the fixed guidance means include multiple portions of supplemental walls, forming stops, associated with the interior of the housing, one of which portions may optionally be located facing the slot.

Preferentially, the said portions of supplemental walls are provided in the form of at least one pair of fins, such that at least one fin is optionally positioned facing the slot, and such that each of the fins in each pair is located:
a) On one of the lateral walls, with the said fins facing each other;
   or
b) On one of the portions of the sole lateral wall, with the said fins facing each other.

Furthermore, in a preferred implementation of this embodiment of the invention, the guidance means include at least two pairs of fins, with the axis linking the fins in one pair being perpendicular to the axis linking the fins in the immediately adjacent pair.

The said fins include, in particular, two transverse edges, consisting of a first transverse or upper edge represented by the nearest edge of the feeding compartment, and a second transverse or lower edge represented by the farthest edge of the feeding compartment. In this configuration, the upper transverse edge is joined (for example, by welding or gluing) to the said lateral wall or to the said portion of the sole lateral wall, while the lower transverse edge is kept in a floating position. Furthermore, each fin forms, either with the lateral wall to which it is joined or with the portion of the sole lateral wall to which it is joined, an angle oriented in the direction of travel of the loaf of bread. Moreover, the amplitude of this angle may vary in accordance with the elastic deformation capacity of the said fin, thereby forming a spring, when a certain amount of force is applied to the said fin, which force consists, in particular, of the pressure exerted by the said loaf of bread in transit within the housing. The said elastic deformation capacity of the fin is advantageously employed in dealing with variations in the thickness and/or width of the various types of loaves to be sliced.

During the implementation of this second embodiment of the device according to the invention, which embodiment is characterized by a movable position of the shaft supporting the cutting blade, the loaf is sliced over its entire width when the shaft of this blade is in the proximal position, or else is simply sliced over the smallest desired fraction of the said width when the said shaft is in the distal position.

According to a supplemental characteristic of the invention, the housing is provided internally with means for starting and stopping a motor that drives the shaft that carries the blade. In particular, for example, the starting and stopping means may be equivalent to a switch that is opened or closed by the presence or absence of pressure exerted during deformation of the guidance means following contact or a lack of contact with the loaf to be sliced.

However, when the said guidance means consist of multiple pairs of fins, the appropriate means for starting the motor advantageously come into contact with a fin that is part of the said guidance means and that is located in the feeding compartment, while the appropriate means for stopping the motor advantageously come into contact with a fin that is part of the said same guidance means and that is located in the cutting compartment. These contacts are usually the result of a deformation of the said fins, due to their elasticity. In an embodiment of the said starting and stopping means, starting takes place when the appropriate fin comes into contact with the starting means located in the feeding compartment, due to the pressure exerted by the loaf of bread. Conversely, stopping occurs when the appropriate fin breaks contact with the stopping means, after the loaf of bread has passed. The appropriate means for starting or stopping the motor in this way customarily involve a pressure sensor or a switch.

Alternatively, the starting and stopping means may consist of a light sensor, such as a photoelectric cell, located inside the feeding compartment, with the interruption or non-interruption of the light beam by the loaf of bread starting or, conversely, stopping the motor that drives the circular blade.

Moreover, in another embodiment of the invention, the housing includes a third compartment, known as the “receiver”, which itself is divided into two chambers, i.e., a first chamber (the upper chamber) for receiving the sliced loaf, which is separated from a second chamber (the lower chamber) by means suitable for allowing the passage of the crumbs produced by the cutting action while preventing the passage of the sliced loaf. Such means may advantageously consist of a separating screen.

Conversely, in a supplemental embodiment of the invention, the previously described receiver may be completely separated from the housing. This embodiment is indicated particularly when the loaf of bread to be sliced is particularly long.

So as to complete the housing in an advantageous manner, the receiver and the crumb compartment are separated by a screen that is suitable for ensuring the passage of the said crumbs while holding back the sliced loaf.

The housing that is part of the device according to the invention, as well as all of the associated accessories (such as the guidance means, the sensor, the circular blade, and the other elements) are made of materials that are appropriate for use with food products. The materials in question advantageously consist of the metallic material, such as stainless steel; a synthetic polymer material, such as polyurethane; or a polyacetal polymer, such as the material known as Ertacetal®.

The invention will be better understood, and its other goals, characteristics, and advantages will become more clear, through a reading of the following explanatory description, which makes reference to the attached drawings, which are provided solely as examples illustrating one embodiment of the invention, and on which:

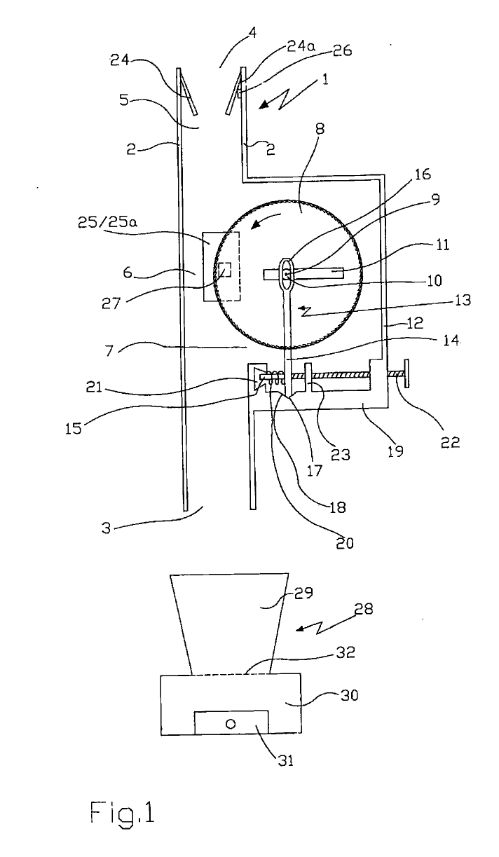

FIG. 1 is a frontal cross-sectional view along the X-X axis of a cutting device according to the invention;

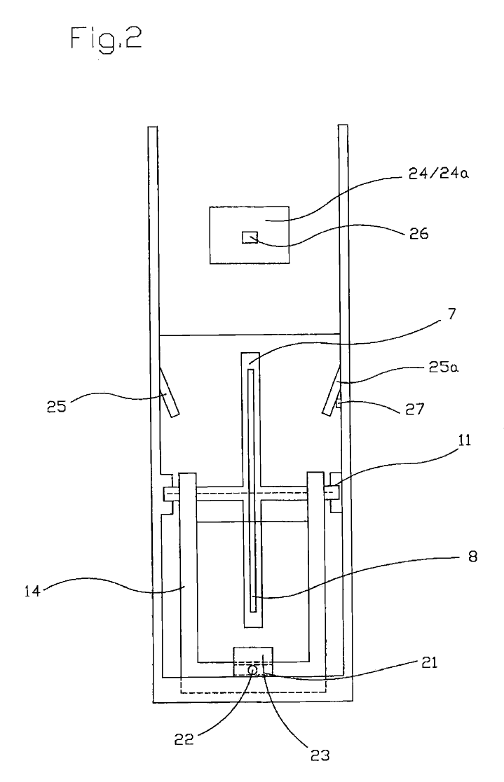

FIG. 2 is a lateral cross-sectional view of the device shown in FIG. 1; and

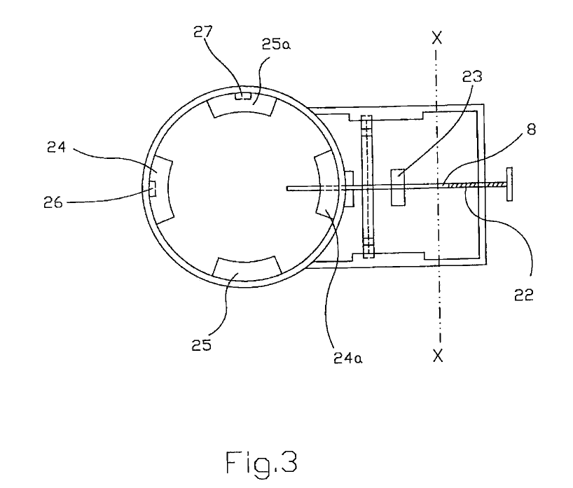

FIG. 3 is a transverse cross-sectional view of the device shown in FIG. 1 and in FIG. 2.

As shown in FIG. 1, the slicing device according to the invention includes a housing 1 consisting essentially of a single lateral and longitudinal wall 2. Furthermore, this housing is open at its circular transverse base 3 and also at its top 4, which is also circular. The resulting cylinder is divided longitudinally into two compartments, i.e., a feeding compartment 5 for the introduction, for example, of a baguette loaf to be sliced, and a compartment 6 for cutting the said baguette loaf. Furthermore, a portion of the lateral wall 2 includes a longitudinal slot 7 that allows the passage of a circular cutting blade 8. This blade is mounted on the transverse shaft 9, which can rotate in place when driven by an electric motor (not shown) connected to this shaft in such a way as to drive the rotation of the said blade in a counterclockwise direction. Moreover, the said shaft 9 is mounted on a roller bearing located inside a supporting tube 10 whose extremities can be shifted, in grooves 11 formed in the wall 12 of a protrusion of the housing 1, from a position at the proximal extremity in relation to the slot 7 to a position at the distal extremity. The mechanism also includes a brace 13 consisting of a longitudinal portion 14 and a transverse portion 15. The extremity 16 of the portion 14 is also secured to the shaft 9 located in the supporting tube 10, while the opposite extremity 17 is mounted such that it can pivot in a groove 18 formed in the base 19 of the protrusion. Furthermore, the transverse portion 15, which supports a spring 20, is likewise inserted such that it can pivot in a groove 21 formed in the wall 2, while a threaded rod 22 passes through the wall 12 and the supporting base 23, cooperating with an internal threading located in the said same wall and supporting base.

FIG. 1 also shows how the wall 2 of the housing 1 is also provided with a first portion of guidance means that are capable of ensuring the centering of the loaf of bread, which first portion takes the form of a pair of fins 24, 24a located facing each other in proximity to the feeding compartment 5, with each fin forming a spring. However, it should be noted that the fin 24 is securely affixed to the portion of the sole wall 2 facing the slot 7. Consequently, the said fin constitutes the reference guiding wall for the determination of the distance separating it from the extremity of the blade 8. Furthermore, the said same wall 2 is also equipped with a second portion of the guidance means, in order to maintain the direction initiated by the first portion. The said second portion of the guidance means is represented by a pair of fins 25, 25a that are likewise located facing each other in proximity to the cutting compartment 6, with each of the said fins likewise forming a spring. Moreover, each of the said fins 24, 24a and 25, 25a is securely affixed to the wall 2, forming an angle therewith, which angle is oriented toward the blade 8. Furthermore, as shown in FIG. 3, the axis joining the pair of fins 24, 24a is perpendicular to the axis joining the pair of fins 25, 25a, so as to preserve and, if necessary, improve the guiding of the loaf during its passage through the housing.

FIG. 1 also shows the presence of a first pressure sensor 26 located in proximity to the fins 24, 24a and connected to the drive motor in order to start the rotation of the blade, as well as a second pressure sensor 2, located in proximity to the fin 25a, that is suitable for stopping the said motor.

Furthermore, FIG. 1 shows how the resulting assembly is supplemented by a receiver 28 consisting of a compartment 29 intended to receive the sliced loaf, and a compartment 30, provided with a drawer 31, for recovering the crumbs produced during the cutting operation. These two compartments are separated from each other by a screen 32 that is suitable for allowing the passage only of the said crumbs, and not of the sliced loaf.

In view of the foregoing description, it will be noted that when the device according to the invention is implemented, the position of the blade 8 is first adjusted in accordance with the depth of the desired cut in the direction of the width of the loaf to be sliced. For this purpose, the threaded rod 22 is pushed in the direction of the cutting compartment 6 or in the opposite direction, so as to compress or release, respectively, the spring 20 by means of the brace 13, which actuates, in the groove 11, the supporting tube 10 that is provided with the shaft 9, moving the said tube toward the cutting compartment or in the opposite direction, respectively. The more the said spring is compressed, the greater the portion of the blade present inside the cutting compartment, and the deeper the slicing of the width of the loaf.

The loaf to be sliced is then introduced through the opening 4 in the housing, which introduction pushes the pair of fins 24, 24a apart, toward the wall 2. As a result of the pressure exerted by the fin 24a on the pressure sensor 26, the motor that drives the blade 8 is actuated, thereby causing the said blade to rotate in the direction indicated by the arrow in FIG. 1. As the loaf of bread passes through the housing, it encounters the blade 8, which, due to its rotation, propels the loaf between the fins 25, 25a, while slicing the loaf longitudinally to the previously determined cutting depth. The said fins 25, 25a are pushed apart toward the wall 2, thereby ensuring the preservation and reinforcement of the centering and of the guidance provided by the fins 24, 24a. Once the loaf has been sliced over its entire length and therefore ceases to apply pressure to the fins 25, 25a, the said fins cease to be pressed apart, returning toward each other and breaking their contact with the pressure sensor 27, thereby causing the stoppage of the motor driving the blade 8. The sliced loaf is then recovered in compartment 29 of the receiver 28, while the crumbs are collected in the compartment 30, i.e., essentially in the drawer 31, after having passed through the screen 32.

The device according to the invention possesses substantial advantages in comparison to the known and utilized devices. First of all, it undeniably increases the safety of the user, because the user's hands are no longer in contact with the loaf while the loaf is being sliced. Consequently, potential wounds and damage to the palm and fingers, due to the abrasive effect of the crust of the loaf, can be avoided. Furthermore, the device makes it possible to maintain a clean and crumb-free working area for users who wish to place various fillings in the sliced or simply opened loaf.

1. Method for slicing loaves of bread, particularly loaves having an oblong or essentially oblong shape, characterized in that, inside a housing consisting of one or more longitudinal lateral walls defining a first compartment, known as the “feeding compartment”, for the introduction of the loaf of bread to be sliced, and a second compartment, known as the “cutting compartment”, whose sole lateral wall, or one of whose lateral walls, is provided, in proximity to the cutting compartment, with a longitudinal slot for the passage of a circular cutting blade that can rotate counterclockwise and that is mounted rotatively on a shaft external to the housing, the loaf is placed in the feeding compartment after the distance inside the housing between the extremity of the blade and, located facing the slot, the means for guiding the loaf, has been adjusted as necessary, such that, due to the effect of the rotating blade, the loaf, to which motion has been imparted by the tractive force of the said rotating blade, is sliced longitudinally over its entire length or over a portion thereof, and the sliced loaf is then received.

2. Method according to claim 1, characterized in that the distance is adjusted by changing the position of the guidance means and/or of the shaft carrying the blade.

3. Method according to claim 2, characterized in that the position of the guidance means is changed by shifting the said means, inside the housing, along an axis perpendicular to the axis of the blade, from a position at the distal extremity (in relation to the slot) to a position at the proximal extremity, and conversely.

4. Method according to claim 2, characterized in that the position of the shaft carrying the blade is changed by shifting the said shaft, outside the housing, from a distal extremity to a proximal extremity, and conversely.

5. Device for the implementation of the method according to claim 1, which device consists of a housing consisting of one or more longitudinal lateral walls defining a first compartment, known as the “feeding compartment”, for the introduction of the loaf to be sliced, and a second compartment, known as the “cutting compartment”, and, optionally, a third compartment, known as the “receiver”, for receiving the sliced loaf, characterized:
In that its sole lateral wall, or one of its lateral walls, is provided, in proximity to the cutting compartment, with a slot for the passage of a circular cutting blade that can rotate counterclockwise and that is mounted rotatively on a shaft external to the housing, with the position of the said carrying shaft being stationary or movable in relation to the slot, and with the length of the portion of the blade located inside the cutting compartment being essentially equal to or less than the width of the said compartment; and
In that it includes, located inside the housing and, optionally, facing the slot, stationary or movable means for guiding the loaf of bread.

6. Device according to claim 5, characterized in that when the shaft carrying the blade is stationary, the guidance means include, facing the slot, the lateral wall of the housing, a portion of the sole lateral wall of the housing, or a supplemental wall associated with the interior of the housing, which lateral wall, portion of the sole wall, or supplemental wall being movable from a position at the distal extremity to a position at the proximal extremity, and along an axis perpendicular to the shaft carrying the blade.

7. Device according to claim 5, characterized in that the position of the shaft carrying the blade is movable from a position at the proximal extremity, in relation to the slot, such that the cutting line of the said blade occupies essentially the width of the cutting compartment up to a position at the distal extremity, such that the cutting line of the said blade slightly penetrates the interior of the said cutting compartment.

8. Device according to claim 5, characterized in that when the position of the shaft carrying the blade is movable, the guidance means include, facing the slot, the lateral wall of the housing, a portion of the sole lateral wall of the housing, a supplemental wall associated with the interior of the housing, or a portion of a supplemental wall associated with the interior of the housing.

9. Device according to claim 5, characterized in that when the position of the shaft carrying the blade is movable, the guidance means include multiple portions of supplemental walls associated with the interior of the housing, one of which portions may optionally be located facing the slot.

10. Device according to claim 9, characterized in that the portions of supplemental walls are provided in the form of at least one pair of fins, such that at least one fin is optionally positioned facing the slot, and such that each of the fins in each pair is located:
a) On one of the lateral walls, with the said fins facing each other;
or
b) On one of the portions of the sole lateral wall, with the said fins facing each other.

11. Device according to claim 10, characterized in that the guidance means include at least two pairs of fins, with the axis linking the fins in one pair being perpendicular to the axis linking the fins in the immediately adjacent pair.

12. Device according to claim 10, characterized in that each fin includes a first transverse edge that is joined to the lateral wall or to a portion of the sole lateral wall, and a second transverse edge that is kept in a floating position.

13. Device according to claim 12, characterized in that each fin forms, either with the lateral wall to which it is joined or with the portion of the sole lateral wall to which it is joined, an angle oriented in the direction of travel of the loaf of bread, the amplitude of which angle may vary when a certain amount of force is applied to the said fin by the said loaf of bread in transit within the housing.

14. Device according to claim 5, characterized in that it is provided internally with means for starting and stopping a motor that drives the shaft that carries the blade.

15. Device according to claim 14, characterized in that the starting means are suitable for coming into contact with one of the fins of the guidance means, which fin is located in proximity to the feeding compartment, and in that the stopping means are suitable for coming into contact with one of the fins of the guidance means, which fin is located in proximity to the cutting compartment.
